(19) United States
(12) Patent Application Publication
(10) Pub. No.: US 2008/0249829 A1
(43) Pub. Date: Oct. 9, 2008

(54) System and Method for Co-Ownership and Use of a Plurality of Properties

(76) Inventor: Robert Keith Vicino, Solana Beach, CA (US)

Correspondence Address: ERIC HANSCOM, 7395 PORTAGE WAY, CARLSBAD, CA, 92011, US

(21) Appl. No.: 12/017,318

(22) Filed: Jan. 21, 2008

Related U.S. Application Data
(60) Provisional application No. 60/881,610, filed on Jan. 22, 2007.

(51) Int. Cl. G06Q 10/00

(52) U.S. Cl. 705/9; 705/8

(57) ABSTRACT

A system and method for enabling a plurality of owners to have the right of exclusive use of a plurality of properties, such as yachts or homes, in various geographic locations throughout the world for a period of time based on a rotating usage schedule. A majority of the owners have an undivided interest in one or more properties, yet has equal rights of exclusive use of a majority of the properties in the system, subject to the rotating usage schedule. Alternatively, the owners may collectively own an undivided interest in a group of properties and have an equal right of exclusive use of a majority of the properties in the system, subject to the rotating usage schedule. One or more management entities manage the properties, rotating usage schedule, staffing, maintenance, insurance, permitting, licensing, registration, oversight of legal issues, provisioning, payment of expenses and taxes, renting, or any combination thereof.

### CROSS REFERENCE TO RELATED APPLICATIONS

This application relates to and claims the benefit of provisional application 60/881,610 filed on Jan. 22, 2007, which is hereinafter incorporated by reference.

### STATEMENT REGARDING FEDERALLY SPONSORED RESEARCH OR DEVELOPMENT

This invention was not federally sponsored.

### INVENTOR

Robert Keith Vicino

### BACKGROUND OF THE INVENTION

### Field of the Invention

This invention relates to the general field of co-ownership of properties, and more specifically toward a system and method for enabling a plurality of owners to have the right of exclusive use of a plurality of properties, such as yachts or homes, in various geographic locations throughout the world for a period of time based on a rotating usage schedule that determines usage by the owners. Each owner has an undivided interest in one or more properties, yet has an equal right of exclusive use of a majority, but preferably all, of the properties in the system, subject to the rotating usage schedule. Alternatively, the owners may collectively own an undivided interest in a group of properties within a system and have an equal right of exclusive use of a majority, but preferably all, of the properties in the system, subject to the rotating usage schedule. In general terms, there are one or more management entities that manage the real or personal property, and take care of any staffing needs, maintenance, insurance, permits, licensing or registrations, oversight of all legal issues, provisioning, and the payment of expenses and taxes of the property, if applicable. A preferred embodiment of this invention is a method for managing one or more fleets of yachts where the yachts are in different geographic locations, and a rotating usage schedule determines usage of the yachts by the owners. More specifically for this embodiment, which shall be used for general illustrative purposes, the one or more management companies can handle crewing issues, dockage, maintenance of the yachts, any multinational registration issues, etc. One or more management entities manage the properties, the rotating usage schedule, crew, staffing, dockage, maintenance, insurance, permits, licensing or registrations, oversight of all legal issues, provisioning, and the payment of expenses and taxes of the property, if applicable.

Various types of properties, both real and personal, can be used in this system and method. One such type of property is a yacht. In this embodiment of the invention, yachts can be based in the most seasonable and desirable ports of the world. These yachts can also be repositioned to different ports if desired. The yachts may have one or more crew members to manage and operate the yacht. Another envisioned type of property is real estate. Homes, condominiums, and other forms of real property can be located in the most seasonable and desirable geographic locations around the world. The properties may be staffed to operate and serve the owners using the specific property.

The term yacht was originally used for a light, fast sailing vessel used by the Dutch Navy to pursue outlaws in and around shallow waters. After Charles II of England used such a vessel for his return to Britain from the Netherlands, the term yacht was used for vessels that transport important persons. Yachts are now considered to be a wide range of vessels that are most often used for pleasure cruising or racing. Yachts can be propelled by sails, motors, or both and can range from less than twenty feet in length to more than two-hundred feet in length. Yachts can be hand-constructed from native timbers in countries such as Thailand and Indonesia for several thousand dollars, or built with modern composite materials in technologically advanced shipyards for millions of dollar. Most yachts are out of affordable reach by all but the most wealthy individuals and corporations.

Vacation homes have been around for many years. Often, an owner will purchase or lease a home or condominium in a desirable geographic location away from his or her primary residence. This allows him or her to have exclusive use of real property in a geographic location of his or her choosing. Sole ownership, however, can be very expensive when considering not only the initial cost of the property, but also the maintenance required, especially when compared to renting or purchasing a timeshare in a property. Further, ownership of a single property does not allow the guaranteed use of properties in various geographic locations around the world.

Due to the price and cost of ongoing ownership of properties such as real estate and yachts, more and more people are turning to co-ownership and co-leasing programs to help share and offset both the upfront investment and the expense of ownership and use of the property. These programs are fundamentally known as fractional ownership and use, or shared ownership and use, where multiple owners or lessees of one property share the costs involved in owning that property. Most programs also provide for third party management of the property, relieving the co-owners, or lessees of the time and effort required to maintain their own property.

It has been stated that fractional ownership of property started in Europe in the early 1960s with ski resort properties, and made its way to the United States by the late 1960s. Developers found that they could finance and sell their properties into fractional ownership or timeshares and it has been found that by the 1990s there were more than four million timeshare owners. It has extended beyond real estate to yachts, jets, helicopters, and even motorized vehicles.

Most of these fractional ownership programs allow each owner to share in the use of the property by utilizing various forms of a shared access schedules, guaranteed minimum and or maximum number of days of use per year, or by mutually agreed upon rules and regulations. Additionally, one of the primary benefits of fractional ownership is that by sharing the cost and expense of property ownership, people can “own” and, more importantly for most, use a larger, more expensive property than they would otherwise be able to afford on their own.

While there are many benefits to fractional ownership of a yacht, or boat, fractional ownership systems of a single yacht typically lead to an owner's boredom with the use of the yacht based in just one port or approximate geographic location. The yacht may be relocated to different areas around the world during different times of the year, but this would require the owners of the yacht to agree on the geographic locations of the boat. Some owners may be unhappy with the port or region chosen, or displeased with their access to the yacht. Additionally, due to the great distances and difficulties of repositioning a yacht from one region of the world to another, the transit cost, expense and added wear and tear on the vessel would be cost prohibitive. The down time for relocation of a single yacht from port to port, or region to region, would greatly reduce and significantly limit the owner's usage time during these transit periods.

Some programs also provide for the ability to use a variety of properties within their system. One program allows a party to use a property, such as a house or a yacht, whenever a property is available based on a first come first served basis, generally within the party's size category or less. Other programs offer a voluntary exchange capability with other owners in other geographic locations or ports. However doing so typically requires an involved procedure to negotiate, make, schedule, and confirm the arrangements. While it is possible to make such a voluntary exchange between the owners of two properties, such exchanges are a novelty and rarity of co-ownership programs due to the difficulty and unpredictability of making the exchange.

Thus there has existed a long-felt need for a system and method where an owner can have the benefits of partial or fractional ownership of a property, either real property or personal property, without having to use the same property in the same geographic location time after time. The owner should be entitled to use a majority of the properties, and preferably each and every property, of the system before he or she has the right to use the same property again. The various properties of the system should be comparable in price, value, size, ability, and accommodations, and located throughout the world in the most desirable geographic locations. Additionally, the properties should be well maintained and have adequate crew or staff associated with each property to make an owner's use of the property a pleasurable experience.

The current invention provides just such a solution by having a system and method for enabling a plurality of owners to have the right of exclusive use of a plurality of properties in various geographic locations around the world for a period of time on a rotating usage schedule. A majority of the owners, and preferable each owner, have an undivided interest in at least a single property, yet have an equal right of exclusive use of a majority, but preferably all, of the properties in the system, subject to the rotating usage schedule and rules and regulations established by the owners or a management entity. A management entity, or group of entities, manages the properties, the rotating usage schedule, crew or staffing, dockage, maintenance, insurance, permits, licensing or registrations, oversight of all legal issues, provisioning, and the payment of expenses and taxes, as well as positioning of the properties, if applicable, in the most seasonably desirable geographic locations within their respective regions of the world. Yachts may have one or more full or part-time crew members to manage and operate each yacht. Homes or condominiums may have one or more full or part-time staff to manage and operate the property. Some of the owners, and preferable all of the owners, will have the pleasure of using a majority, and preferably each and everyone, of the properties in the system on a predictable schedule and frequency, progressively going from port to port, geographic location to location, or region to region of the world with the benefits of ownership, but without the prohibitive cost that would otherwise be required to either individually own as many properties in as many geographic locations, or to relocate a single property, such as a yacht. Over time, each owner will enjoy properties in some of the most desirable geographic locations of the world, with new enthusiasm for discovering the culture, charm, character and features of each geographic location, while affordably leveraging their investment and ongoing expense.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

A unique feature of the current invention is how the co-owners are each provided a designated time to use a majority of the properties in the system thereby assuring each owner an equal right of exclusive use and enjoyment of a majority, but preferably all, of the properties. Instead of owning just one property in one geographic location, this invention enables owners to enjoy the use of many properties located in the best geographic locations around the world while that owner only owns a share of one of the properties in the system.

The invention encourages each owner to use all of the properties in the system throughout the term of ownership of a property in the system. Doing so helps each owner maximize his or her benefit of ownership while minimizing their expense and management of the properties through co-ownership. Previous systems, such as an exchange program, require a co-owner wishing to exchange his or her right to use a single property with a co-owner of another property to negotiate directly with that co-owner or through a management entity. The current invention eliminates this requirement to negotiate an exchange for the right to use another property. Instead, it provides a predictable schedule that enables each owner to forecast his or her date and time of use of a plurality of properties throughout the world.

With the current invention, each owner may enjoy more benefits of property ownership in more geographic locations for a fraction of the cost compared to sole ownership of a single property or the significant cost of owning several properties positioned in different geographic locations around the world. Expenses associated with ownership of a property can also be pooled with other properties in the system, thereby averaging the operational costs and expenses of all of the properties. Therefore, if one of the properties has higher than average expenses for a year, this cost can be spread between all the owners of the system. This creates a more predictable cost structure for budgeting and actual out of pocket expenses associated with property ownership. These features make a lifestyle previously only enjoyed by the privileged and wealthy few available to a wide range of people.

One embodiment of the current invention is where each property is a yacht. A plurality of owners have an ownership interest in each yacht. A plurality of yachts each owned by a plurality of owners are then placed into a system, where each owner is entitled to exclusive use of a majority, but preferably all, of the yachts in the system pursuant to a rotating usage schedule. Further, each owner should have the right of exclusive use of a majority of the yachts, if not all the yachts, before that same owner is entitled to use the same yacht again. At least two of the yachts should be based in different ports at any one time. A port, as used previously and hereinafter, is intended to mean a town or a city with a harbor where one or more water going vessels can dock. When a yacht is referred to as being in a port or geographic location, it is meant that the yacht is based in that port or geographic location. It is preferable, however, that a majority, if not all, of the yachts are in different ports around the world. This is truly a beneficial system and method for an owner that would prefer to see the world on a private yacht for a fraction of the cost and expense when compared to owning and managing just one yacht, in one port.

Another embodiment of the current invention is where each property is real property, such as a house or condominium. A plurality of owners have an ownership interest in a specific piece of real property. A plurality of houses, condominiums, other forms of real property, or any combination thereof are then placed into a system where each owner is entitled to exclusive use of a majority, but preferably all, of the pieces of real property in the system pursuant to a rotating usage schedule. Further, a majority, and preferably each and every owner, should be entitled to exclusive use of a majority of the pieces of real property, if not all of the pieces of real property, in the system before the same owner has the right of exclusive use of the same property again. This scheduled rotation is a key to the invention and actually may allow an item of personal property, such as a yacht, to increase in value over time as opposed to most personal property that only decrease in value over time. Previous to this invention, there has not been a system or method that gives each owner a right to use a majority, if not all, of the properties in the system during different times of the year without the need to reserve, exchange, or bid for the specific properties.

It is also possible that different forms of property are used in a single system. For example, one system could contain properties such as homes, condominiums, and yachts. This allows owners of one type of property to have use of the other types of properties in different geographic locations around the world. Preferably, each of the properties in this system would be of approximate equal value.

At least two of the pieces of real property should be in different geographic locations around the world, where different geographic locations are different cities or towns. It is preferred, however, that a majority, if not all, of the real properties are located in different cities or towns, and in different countries around the world. This is truly a beneficial system and method for an owner that would prefer to experience different parts of the world while living in a house or condominium for a fraction of the cost and expense when compared to owning and managing just one property in one geographic location.

There are various other forms of property that can be used in the current invention without departing from the scope of the claimed invention, including mobile homes, aircraft, submersibles, houseboats, or any other type of property that would benefit from the current system and method.

It is a principal object of the invention to provide a system and method to enable a plurality of owners to own a fraction of a single property, real or personal, yet also have the right to exclusive use of multiple properties.

It is another object of the invention to provide a system and method that allows an owner to enjoy multiple different properties in multiple different geographic locations by simply owning a fraction of a single property.

It is also an object of the invention to provide a system and method where an owner is entitled to exclusive use of a majority of the properties in the system before the owner is entitled to exclusives use of the same property again.

It is an additional object of the invention to provide a system and method that allows co-owners of a property to enjoy the benefits of property ownership without the management hassle of dealing with crew, staffing, dockage, maintenance, insurance, permits, licensing or registrations, oversight of all legal issues, provisioning, and the payment of expenses and taxes of the property, if applicable.

It is an additional object of the invention to provide a system and method that allows co-owners of a property to share the ongoing operational cost and expense of ownership within a pool of other properties also in the system, thereby averaging the operational costs and expenses of all of the properties.

It is a final object of this invention to provide a system and method of property ownership that is more affordable and beneficial to the owner when compared to sole ownership of a single property in a single geographic location.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a diagram of the organizational structure of one embodiment of the current invention.

FIG. 2 is a diagram of the basic method of the current invention.

FIG. 3 is a diagram of another embodiment of the method for co-ownership and use of a plurality of yachts.

FIG. 4 is a chart of an embodiment of the rotating usage schedule.

FIG. 5 is a diagram of the various relationships between different management entities used in the current invention.

### DETAILED DESCRIPTION OF THE FIGURES

Many aspects of the invention can be better understood with reference to the drawings. The components in the drawings are not necessarily drawn to scale. Instead, emphasis is placed upon clearly illustrating the components of the present invention. Moreover, like reference numerals designate corresponding parts through the several views in the drawings.

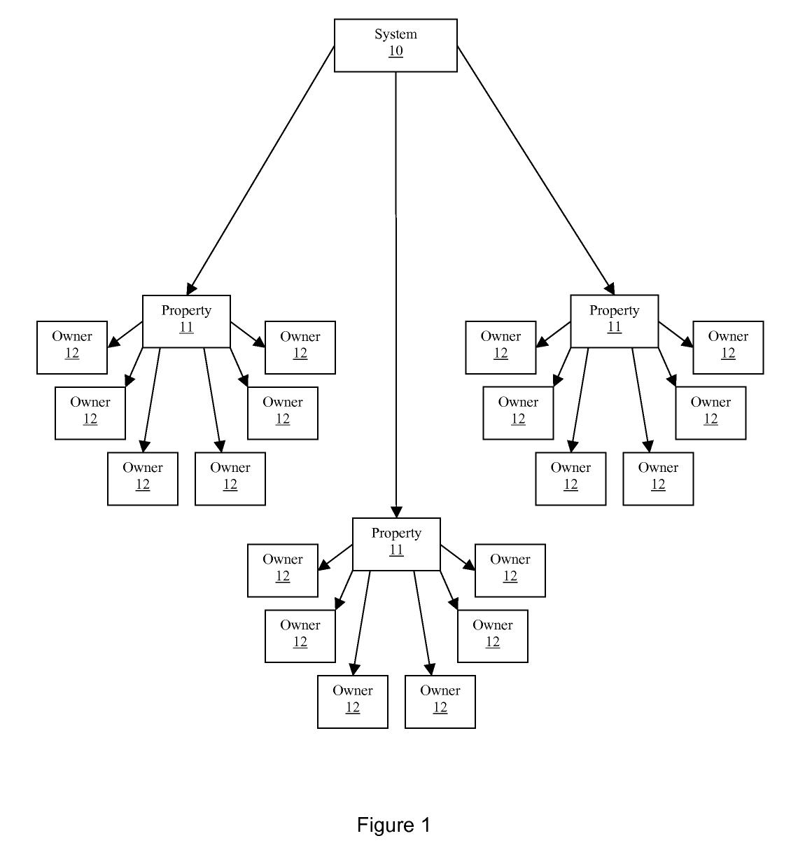

FIG. 1 is a diagram of the organizational structure of one embodiment of the current invention. The current invention can be a system 10 that includes a plurality of properties 11. Each of the properties 11 is owned by a plurality of owners 12. It is envisioned that each property 11 is approximately of equal size, accommodations, and value. While the number of owners 12 per property 11 within the system 10 may vary, it is important that all the properties 11 in the system have the same number of owners 12 with equivalent usage rights or at least all the owners have an ownership interest that is approximately the same as all the other owners. In this figure, there are six owners 12 per property 11. However, it is possible that one or more of the owners 12 of a property 11 within the system 10 may be a restricted owner 11 with no usage rights of the property 11, or any other property in the system 10.

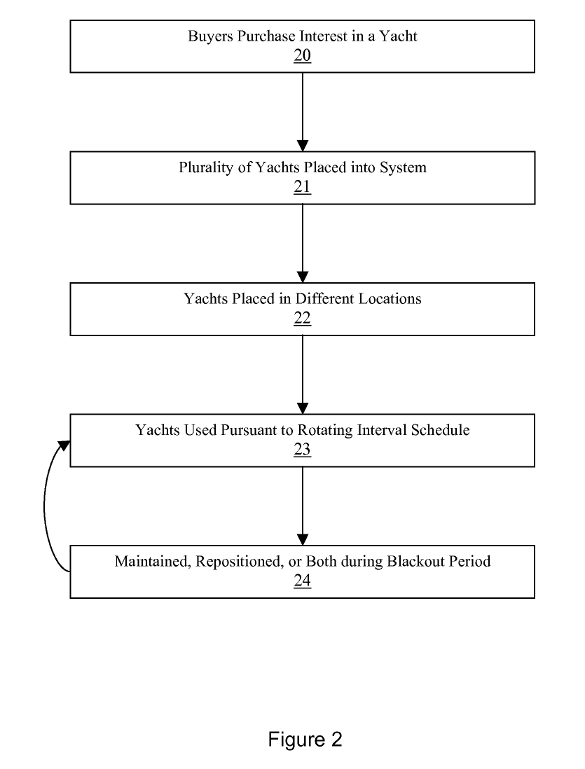

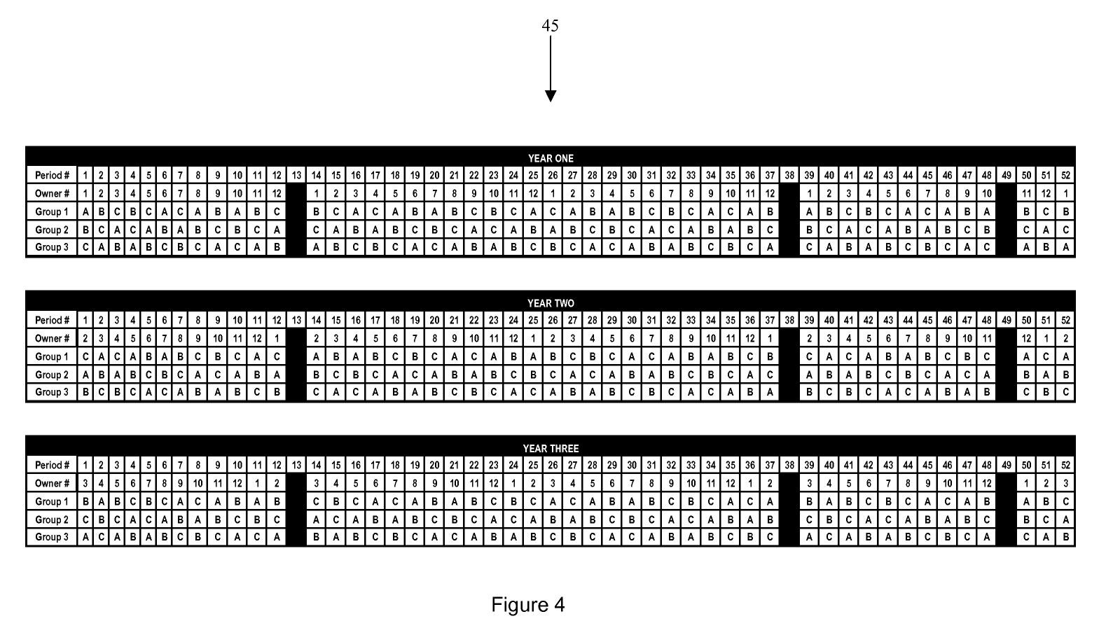

FIG. 2 is a diagram of the basic method of the current invention where each property is a yacht. First, one or more buyers purchase an interest in a yacht 20, such that the combination of interests in the yacht is sufficient to purchase, or sell the entire yacht. The step of buyers purchasing interests in a yacht 20 is repeated until a target number of yachts have been purchased. The number of yachts in the system should allow for a rotating schedule that ensures a majority of the owners, but preferably each and every owner, are entitled to the exclusive use of each yacht over a period of time without having the right to use the same yacht again until the owner has been entitled to use every other yacht in the system. It is has been determined that three, five, seven, and eleven properties within the system allow for such a rotating schedule. Once the target number of purchased yachts has been reached, the plurality of yachts are placed into the system 21. The yachts are then placed in different ports 22 around the world. These geographic locations can be set throughout the year or can change to meet seasonal needs and should be popular geographic locations that meet the desires of the owners of the yachts. Each owner then has exclusive use of each yacht pursuant to a rotating usage schedule 23 that is explained in further detail in FIG. 4. There are periods throughout the year where no owner is designated to have use of a yacht, known as blackout periods. A blackout period, as used previously and hereinafter, is intended to mean any temporary period where access to the property is limited or denied. These designated blackout periods may also be used for periods to rent the yacht to non-owners as a means of offsetting the ongoing expenses for all of the owners, or to maintain certain tax provisions or requirements, in which case the yacht would not be scheduled for use by the owners. A yacht can be maintained, repositioned to a different port, preferably within the region, or both during a blackout period 24. The blackout period can also be used to give the crew of the yacht a vacation even if no maintenance or relocation is required. After the blackout period, the yacht is once again used pursuant to a rotating usage schedule 23.

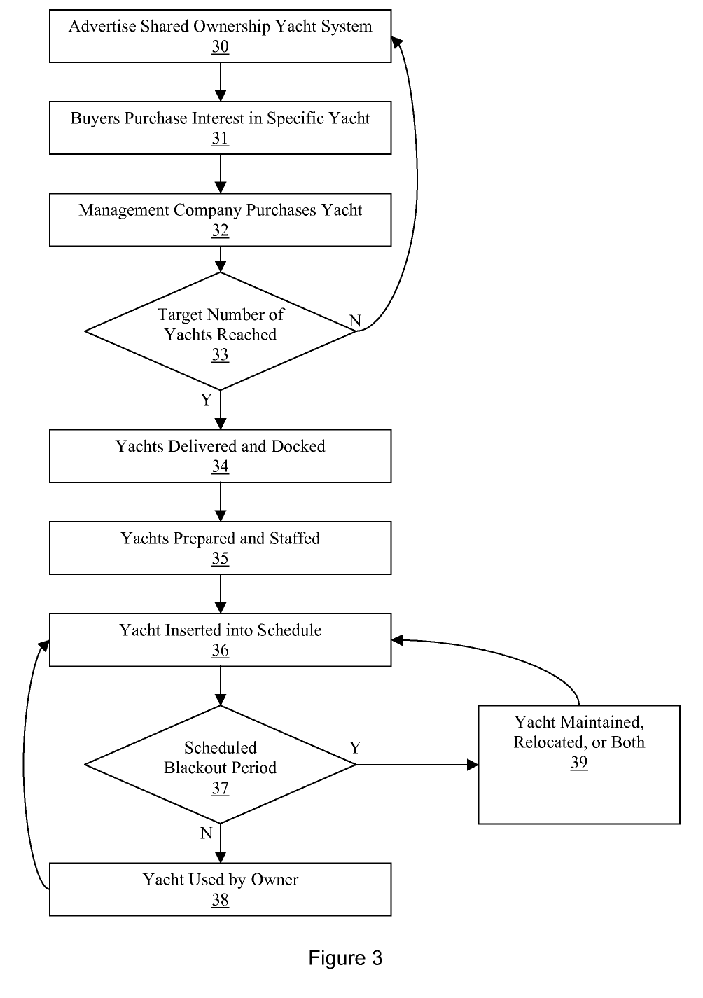

FIG. 3 is a diagram of another embodiment of the method for co-ownership and use of a plurality of yachts. In this embodiment, a management entity advertises a shared ownership yacht club 30, association, organization or entity where co-owners of a yacht can use similar sized and valued yachts around the world. Buyers then purchase an interest in a specific yacht 31. The buyers may also purchase a membership in a yacht club, organization, association, or any form of entity that manages the yacht at the same time. For example, the system may be set up such that each yacht in the system is owned by twelve individuals or entities. In this case, each owner would purchase a specific interest in a yacht along with eleven other buyers. It is important to note that an owner could be a natural person, a group of people, or a legal entity. Further, there are various means for the co-owners of a yacht to own the yacht. The owners could own the yacht directly, such as in a tenancy-in-common form of ownership. Alternatively, the yacht could be owned by a legal entity and each owner owns a proportional interest in the legal entity. The management entity then purchases, or sells the yacht on behalf of, or to the buyers 32. If the target number of yachts 33 has not been reached, then the management entity continues to advertise a shared ownership yacht club 30, association, organization or entity. In other words, the management entity arranges for other buyers to purchase shared interests in similar sized and valued yachts until the target number of yachts is reached. The target number of yachts may have a minimum and maximum for the specific system grouping. It is has been determined that three, five, seven, or eleven yachts within the system are preferable numbers of yachts for both a rotating usage schedule and the diversification of port geographic locations. The system can be activated with a minimum number of yachts and then additional yachts can be added to the system as more owners are sourced for subsequent yachts. Additional yachts can be purchased and then placed into the existing system up to a desired maximum number of yachts within each specific system.

After the target number of yachts is reached 33, each yacht is delivered and docked 34 at a port designated by the management entity. The yachts are located around the world in desirable geographic locations such that the owners of the yachts are able to use a variety of yachts in a variety of geographic locations throughout the calendar year. Each yacht is then prepared and staffed 35 for use by the owners. A skipper is assigned to each yacht to manage and operate that specific yacht. Depending on the size of the yacht and the desires of the particular owner using the yacht, additional full or part-time crew members may be added to provide onboard services. It is also contemplated that the size and make-up of the crew could be adjusted due to the different circumstances under which the yacht would be sailing in the various geographic locations. Additional crew-members could be added as may be requested or required by certain owners during their respective uses of the property. Once the yacht has been properly prepared and staffed 35, the yacht is inserted into the rotating usage schedule 36. At this point, the owners of the yachts in the system begin rotating their right to exclusive use of each yacht pursuant to the rotating usage schedule. As more yachts are added to the system, the rotating usage schedule is adjusted to reflect the additional yachts and owners.

The rotating usage schedule provides for each owner to have a right of exclusive use of a yacht on a rotating basis of equal time periods equal to the total number of owners of each yacht. For example, if there are six owners of each yacht and the equal time period is one week, then the rotating usage schedule will rotate every six weeks such that an owner will generally have use of a different yacht in a different geographic location every six weeks. Some of the equal time intervals, however, are reserved within each calendar year for major maintenance of the yacht. During these periods, no owner has a right to use the yacht and a break is created in the rotating usage schedule.

If the equal time interval is a scheduled blackout period 37 in the rotating usage schedule, the yacht is maintained, relocated, or both 39. Maintenance can include keeping the yacht in proper operating condition as well as refurbishing, upgrading and adding to the amenities on the yacht. This scheduled blackout period can also be used to relocate the yacht to another geographic location. It may be desirable to have a single yacht be in various geographic locations throughout the calendar year. For example, the same yacht may be located in Southern California for part of the year and in Mexico for the other part. It may also be possible to perform maintenance on the yacht while it is being relocated, or immediately before or after the relocation. Further, the yacht could be relocated to perform maintenance, and then returned to its original geographic location once the appropriate maintenance has been performed. It is also contemplated that a yacht could have a saltwater location and a freshwater location, thereby minimizing damage to the yacht caused by various organisms growing on the bottom, as those organisms that grow in saltwater are usually killed by fresh water and vice versa. Once the maintenance, relocation, or both has been completed and the scheduled blackout period has ended, the yacht is once again inserted into the schedule 36. If the equal time interval is not a scheduled blackout period 37, then the yacht is used by an owner 38 pursuant to the rotating usage schedule. However, if an owner 38 wishes to use the yacht during periods of relocation, this blackout period 37 could be scheduled as a use period and the rotating usage schedule would be adjusted accordingly. Additionally, should the yacht require unscheduled maintenance, then the rotating usage schedule could be adjusted accordingly. While it is envisioned that the management entity responsible for maintenance of the yacht subcontracts out these services, it is possible that the management entity itself performs these services.

FIG. 4 is a chart of an embodiment of the rotating usage schedule. The rotating usage schedule 50 is shown for three years in this figure. In this embodiment, there are three properties in the system, each with twelve owners. Each owner is represented by an owner number, and each property is its own group. Therefore, in this embodiment, there are three # 1 owners, three # 2 owners, three # 3 owners, and so on. The calendar year is broken down into fifty-two time periods, each being one week long. The beginning of each year could correspond to the beginning of a calendar year, such that Period # 1 begins on the first week of the year. It is also possible, however, that Period # 1 begins on any other day of the year. Owner # 1 of each group is entitled to use a specified property. Owner # 1 of Group 1 is entitled to use Property A for a period of one week. Owner # 1 of Group 2 is entitled to use Property B for a period of one week. Owner # 1 of Group 3 is entitled to use Property C for a period of one week. During Period # 2, Owner # 2 of each group is entitled to use the corresponding property shown in the chart. The system is set up such that each owner is entitled to use a different property every twelve time periods, or twelve weeks, unless a blackout period 37 is scheduled within any twelve week cycle, at which point the schedule is offset by the blackout period 37. Further, the owner is not entitled to use the same property again until he has been entitled to use every other property in the system beforehand. No two owners will be designated the same property for use during the same time period. Also shown in this chart are the blackout periods, shown as black squares on the rotating usage schedule 50. These occur during Period # 13, Period # 38, and Period # 49. During these time periods, maintenance can be performed on the property. If the property can be moved, such as if the property is a yacht, then the property can be relocated instead of or in addition to the maintenance. The rotating usage schedule 50 also allows for owners to have use of a property during different times of the year as the years progress. For example, while Owner # 1 may have use of a property for Period # 52 during Year 1, Owner # 2 will have use of a property for Period # 52 during Year 2 and Owner # 1 will instead have use of a property for Period # 51.

Although one embodiment of the rotating usage schedule has been shown herein, it is possible to come up with multiple variations without departing from the scope of the current invention. For example, each property could have six owners. The year could also be divided into twenty-six equal time periods, each being two weeks long. There could be a greater or lesser number of blackout periods, and these periods could be for longer or shorter periods of time. In fact, these blackout periods may be distributed anywhere in the calendar thereby creating a break in the sequence of use. Owners are also not limited to using just one system of property ownership with one level of property. A individual, group of individuals, or entity with adequate time and money could use several systems of the current invention simultaneously or systems within a larger system with different levels and types of properties and different schedules such that he or she is able to use properties on a more frequent and varied basis than someone who uses just one system of the current invention. Further, an owner may buy several fractional shares within a single system thereby allowing him or her to have more frequent use or, if the owner has consecutive owner numbers, longer usage periods within the system. What is a key feature of the current invention is the rotation of the owners in relation to the properties such that an owner does not have a right to use the same property twice before having the right to use a majority, but preferably all, of the other properties in the system and an owner does not have the right to use a property during the same time period in any two consecutive years. However, owners could be guaranteed the same weekly periods for consecutive years with one owner paying more or less for the specific periods based on that periods popularity for use of the property. This system also eliminates the possibility of one owner having repeated periods of use of the same property in the same geographic location. For example, if the property is a yacht, one owner will not have the right to use the same yacht in the same port until he or she has had the right to use a majority of the other yachts in the system. Preferably, the owner has to have the right to use all of the other yachts in the system before he or she is entitled to use the same yacht in the same port again. Otherwise, this would limit the other owners from having equal access to the yacht in that port.

One or more management entities are used for the system and method of the current invention. These management entities can be related or completely independent, or can even be one single entity. A management entity, as used previously and hereinafter, is intended to be any legal entity, including an individual, a group of individuals such as a partnership, a limited liability company, a corporation, or any number and combination thereof that performs one or more tasks associated with the system or method of the current invention. A management entity provides the owners of each yacht with a comprehensive management program. This management entity can be the same or a different entity than the one that advertised and assisted in the sale of the properties. The comprehensive management program can include providing or arranging a captain and crew, staffing, cleaning services, concierge services, maintenance of the property, dockage, insurance, permitting, licensing or registration, oversight of all legal issues, provisioning, and the payment of all expenses and taxes, or any combination thereof. The management entity should also provide the owners with a usage program, where the usage program includes the rotating usage schedule that allocates designated time periods that each owner may use a property in the system. The owners of each property also share in the ongoing expenses of either their own property or the expenses of all of the properties pooled together, as billed by the management company at various intervals. The management entity may also delegate, subcontract, or otherwise distribute responsibilities to other management entities for one or more of the tasks performed under the current invention.

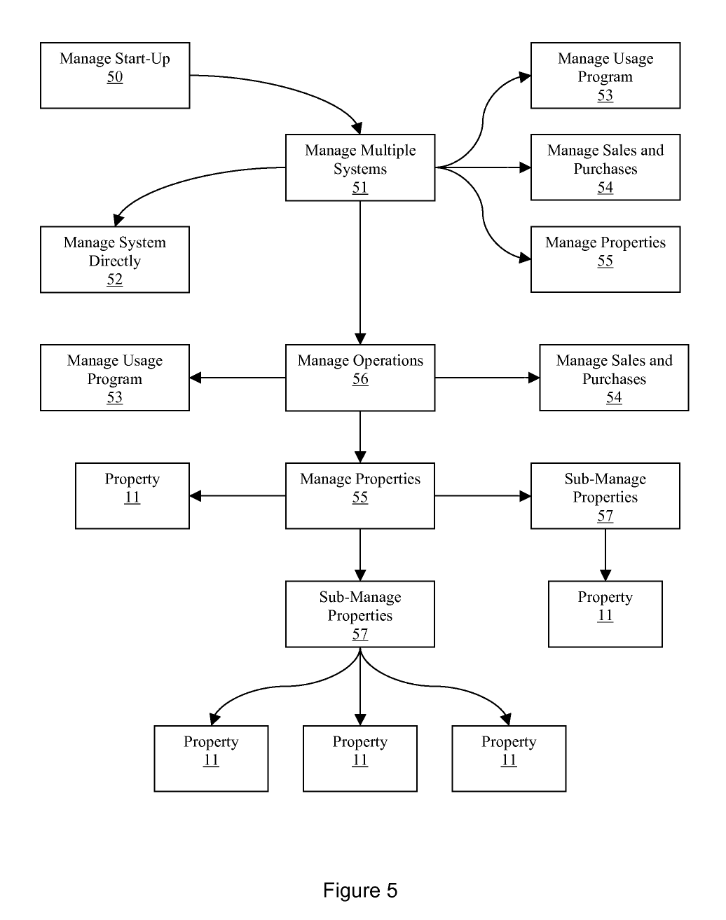

FIG. 5 is a diagram of the various relationships between different management entities used in the current invention. A first management entity can be used to manage the start-up 50 of one or more systems of the current invention. Managing the start-up 50 can include selling interests in the properties, setting up a usage program, and creating additional entities to manage the operation of the system. After the system has been set up, there can be a management entity that manages multiple systems 51. It may manage one or more other management entities that manage a system, one or more systems, or both. A part of managing multiple systems 51 can include managing one or more usage programs 53, managing sales and purchases 54 of properties of one or more systems, and managing one or more properties 55. Each of these can be managed directly or delegated to separate entities or outside organizations to manage that specific task. The management entity that manages multiple systems 51 can also delegate management of one or more systems to another management entity that manages the one or more systems directly 52. The management entity that manages a system directly would manage a usage program, manage sales and purchases of properties, and manage one or more properties itself. Managing multiple systems 51 may also include delegating a system to another entity that manages operations 56, which in turn delegates management to other entities. Managing operations can use additional entities to manage a system, including an entity to manage a usage program 53, an entity to manage sales and purchases 54 of properties, and an entity to manage properties 55. The entity to manage properties 55 can manage a property 11 directly or delegate the management to another entity that will sub-manage the properties 57. These entities that sub-manage the properties would deal with one or more properties 11 directly. It is nonetheless possible, however, that any or all of these entities be combined into one entity that handles any number or all of the necessary management tasks of the system.

For an example of FIG. 5, consider an entity that wishes to start a shared ownership and usage program using the system and method of the current invention by selling interests in five homes located in San Diego, Aspen, Miami, Orlando, and Key West. The entity that manages the start-up 50 can sell the interests in the properties and set up the usage program, and then turn management of the five-home system over to another entity that manages multiple systems 51. Instead of managing this five-home system directly, it elects to delegate the work to another entity that manages the operations 56 of the five-home system. This entity then manages the usage program 53 and sales and purchases 54 of the properties in the five-home system. Another entity can be used to manage the properties 55 of the five-home system. The entity that manages the properties 55 might be located in San Diego, and therefore is able to manage the home in San Diego directly. The remaining properties, however, are located a significant distance from the entity that manages the properties 55, and it may therefore be beneficial to delegate the management of the remaining properties to other entities. The home in Aspen could be managed by one entity. Another entity could manage the properties in Miami, Orlando, and Key West due to their relative proximity to each other.

If the properties in the system can be relocated, such as yachts, the management entity responsible for managing the system should also determine the most desirable and practical geographic location or ports throughout the world in which to base the properties in the system. It is also possible, however, that the owners themselves determine where the properties should be located by collective agreement or some other means of fairly determining the geographic location of the properties for any given time period. The season and the popularity of the geographic location by the owners should be substantial factors in determining where to position and reposition the properties in the system. Whenever appropriate the properties should be repositioned to the most desirable geographic locations throughout the year to allow for the most beneficial use and enjoyment. The management entity should manage and maintain the properties in the system throughout the designated ownership period until each property is sold at a desirable point in its useful life. The management entity can optionally assist the owners in collectively selling the properties out of the system and out of co-ownership. As each property is sold, those owners shall share in the net proceeds of the sale, and thereafter drop out of the rotating usage schedule. The management entity can also optionally assist future owners in purchasing an interest in a property and placing the purchased property into a current system already in place.

In an alternative embodiment of the invention, each owner is required to join a club in addition to purchasing an interest in a specific property. A club can be any association, organization, or entity where co-owners of a property can use similar valued properties around the world. Management of the properties and allocation of use of the properties is provided through the club membership. Established membership rules and regulations of the club govern the use of the properties, where the club maintains and manages the rotating usage schedule.

When the management entity prepares and promotes a shared ownership property program, it may also offer a money-back guarantee. Therefore, if a co-owner of the property is not satisfied with his or her purchase, the management entity will buy back his or her interest in the property, with certain terms, conditions and limitations if desired. This guarantee could extend for any length of time, from a few days to a year or more. Indeed, it is contemplated that a patented system for managing rotational access to yachts could cause the perceived value, and thereby the amount of money an individual would pay to acquire a share, of an ownership in such a system to increase over time. Thus, a user of the invention, whether it be a management company trying to sell an interest or a current owner trying to sell his or her interest, could benefit from an unlimited buy-back program that considers both inflation and the added value such a system brings to the value of a share when calculating what the buy-back price would be. The management entity can offer such a guarantee because the management entity is in the best position to sell the interest to another owner. This can increase the number of potential buyers due to the lower risk of the owner not being satisfied with his or her purchase. The buy-back price could be higher or lower than the initial purchase. While yachts, as do most forms of personal property, tend to decrease in value over time, a patented method of offering co-ownership in rotating yachts could actually increase the value of each “share” over time, wherein new owners may wish to join into the system, while there are a limited number of ownership positions, or yachts currently available. Real property rarely decreases in value, especially over longer periods of time, making a money-back guarantee a low-risk feature to give to potential buyers. The buy back guarantee may be limited to the management entity's ability to resell the fractional interest to the next buyer wishing to have an ownership position within the system.

While it is preferable that the management entity retain no ownership interest in any of the properties, it is possible that the management entity retain one or more interests that may or may not have a right of use in the rotating usage schedule. The retained interest may be of the same or different value than other interests in the property. Selling the entire interest in a property, as used previously and hereinafter, should be considered the entire interest in the property made available to buyers desiring to use the property pursuant to a rotating usage schedule, and exclusive of any interest retained by a management or associated entity. Further, the owners of the property, as used previously and hereinafter, should be considered the owners that have a full, unrestricted right of exclusive use of the property pursuant to the rotating usage schedule, unless certain owners usage rights are greater or more limited based upon the price that a certain owner has paid for his or her respective interest in the property.

There are also various forms of ownership of a property using the current system and method. First, it is preferable that each owner has an undivided interest in a single property, but it is possible that each owner have an undivided interest in multiple properties. Additionally, the undivided ownership interest can be held in fee or as a leasehold wherein each party owns an interest in a leasehold interest in the property. Concurrent ownership of the interests in the property can be in the form of a tenancy-in-common or the property can be owned by a legal entity and each owner owns a proportional interest in the legal entity. It is also possible that a plurality of owners each own an interest in a single entity, where the single entity owns multiple properties, and the owners of the single entity have a right of exclusive use of the properties pursuant to a rotating usage schedule.

Through the use of the system and method of the current invention, owners have a right of exclusive use pursuant to a rotating usage schedule. This right, however, does not preclude the owner from transferring this right to another, whether or not a co-owner of the current system. The owner has a right of exclusive use of a particular property for a specified period of time, and may freely transfer this right to anyone else. One common example is the trading of rights to use a property between owners of the same system, where each owner desires the use of the other's right to use another property for that specified period of time.

Through the use of the current system and method, owners may enjoy more benefits of property ownership in more geographic locations for a fraction of the cost compared to sole ownership of a single property in a single port or geographic location. An owner need not worry about maintaining, upgrading, refurbishing, relocating, staffing, registering, docking, the tax or legal details, or many of the other headaches associated with ownership of a property, real or otherwise. Instead, the owner can reap the benefits of effectively owning and using multiple properties around the world for a fraction of the overall cost.

What I claim is:

1. A system for co-ownership and use of a plurality of properties comprising
one or more entities for managing the system, a plurality of properties, a plurality of owners, and a rotating usage schedule, where a majority of the owners have a right of exclusive use of a majority of the properties within the system for one or more periods of time pursuant to the rotating usage schedule, where at least two properties are in different geographic locations or ports, where each owner owns an interest in at least one of the properties, and where the ratio of owners to properties in the system is at least four to one.

2. The system of claim 1, where the period of time of exclusive use is determined by the rotating usage schedule, and where a majority of the owners have the right of exclusive use of a majority of the properties in the system before an owner has a right of exclusive use of the same property again such that after an owner has had the right of exclusive use of a particular property for a period of time, the owner will not have a right of exclusive use of that same particular property until the owner has had the right of exclusive use for a period of time for a majority of the other properties in the system.

3. The system of claim 1, where the one or more entities for managing the system is responsible for maintaining the properties, where the owners collectively agree on, or one or more entities for managing the system determines, the geographic location or port of each property throughout the world.

4. The system of claim 1, where the rotating usage schedule is divided into equal periods of time, where the rotating usage schedule determines which owner has the right of exclusive use of a particular property during a period of time, and where the rotating usage schedule comprises at least one period of time for each property where no owner is entitled to use of the property, where this period of time is known as a blackout period.

5. The system of claim 1, where the plurality of properties is a plurality of yachts.

6. The system of claim 5, where the one or more entities for managing the system provides the owners of the yachts of the system with a comprehensive management program that comprises maintenance of the yachts, crew staffing of the yachts, arranging for dockage of the yachts, arranging for insuring the yachts, overseeing legal issues related to the yachts, permitting, licensing or registration of the yachts, provisioning of the yachts, and payment of a majority of the expenses and taxes associated with owning the yachts, renting the yachts, or any combination thereof.

7. The system of claim 1, where the plurality of properties is a plurality of real properties.

8. The system of claim 1, where the plurality of owners each have an undivided interest in at least one property in the system, and where the expenses of at least two properties in the system are pooled such that every owner of a property where the expenses are pooled pays an approximately equal amount of expenses proportional to his or her respective ownership interest in one or more of the properties in the system that are pooled.

9. The system of claim 1, where an owner is not entitled to exclusive use of any property in the system for the same calendar periods of time during any two consecutive years.

10. The system of claim 4, where the one or more entities for managing the system oversees maintenance on each property, directly or indirectly, during that property's blackout period, where maintenance on the property comprises maintaining the property, refurbishing the property, remodeling the property, repairing the property, relocating the property, renting the property, or any combination thereof.

11. The system of claim 1, where each property in the system is of a similar value.

12. The system of claim 1, where each property in the system is in a different geographic location or port.

13. A method to enable owners to co-own a single property and have a right of exclusive use of a plurality of properties comprising the steps of
(a) a plurality of owners purchasing a single property
(b) placing the single property into a system of other properties such that there are a plurality of properties in the system, where the other properties are also owned by a plurality of owners, where at least two of the properties are in different geographic locations or ports,
(c) giving a majority of the owners in the system exclusive use of a majority of the properties in the system for a period of time pursuant to a rotating usage schedule,
where the rotating usage schedule is divided into equal periods of time, where the rotating usage schedule determines which owner has the right of exclusive use of a particular property during a period of time, and where the rotating usage schedule comprises at least one period of time for each property where no owner is entitled to use of the property, where this period of time is known as a blackout period, and
where a majority of the owners have the right of exclusive use of a majority of the properties in the system before an owner has the right of exclusive use of the same property again such that after an owner has the right of exclusive use of a particular property for a period of time, the owner will not have the right of exclusive use of that same particular property until the owner has had the right of exclusive use for a period of time of a majority of the properties in the system.

14. The method of claim 13, where one or more management entities oversee maintenance on each property in the system, directly or indirectly, during that property's blackout period, where maintenance on the property comprises maintaining the property, refurbishing the property, remodeling the property, repairing the property, relocating the property, renting the property, or any combination thereof.

15. The method of claim 13, where the single property is a yacht, where the other properties are yachts, and where one or more management entities provides the owners of the yachts with a comprehensive management program that comprises maintenance of the yachts, crew staffing of the yachts, arranging for dockage of the yacht, arranging for insuring the yachts, overseeing legal issues related to the yachts, permitting, licensing or registration of the yachts, provisioning of the yachts, and payment of a majority of the expenses and taxes associated with owning the yachts, renting the yachts, or any combination thereof.

16. The method of claim 13, where each property in the system is of a similar value.

17. A method to enable owners to co-own a single property and have a right of exclusive use of a plurality of properties comprising the steps of
(a) advertising shared ownership for properties where a majority of the owners of a single property have a right of exclusive use of a plurality properties,
(b) selling interests in a specific property, individually or in a group, until the entire property is sold,
(c) repeating steps (a) through (b) until a target number of properties have been sold,
(d) preparing the properties for use by the owners, where at least two of the properties are in different geographic locations or ports,
(e) giving a majority of the owners in the system a right of exclusive use of a majority of the properties in the system for a period of time pursuant to a rotating usage schedule,
where the rotating usage schedule is divided into equal periods of time, where the rotating usage schedule determines which owner has exclusive use of a particular property during a period of time, and where the rotating usage schedule comprises at least one period of time for each property where no owner is entitled to use of the property, where this period of time is known as a blackout period, and
where a majority of the owners have the right of exclusive use of a majority of the properties in the system before an owner is entitled to exclusive use of the same property again such that after an owner has had the right of exclusive use of a particular property for a period of time, the owner will not have the right of exclusive use of that same particular property until the owner has had the right of exclusive use for a period of time for a majority of the other properties in the system, and
where each property is of a similar value.

18. The method of claim 17, where the owners are required to join a club in addition to purchasing an interest in a property, where the club acts as a management entity.

19. The method of claim 17, where one or more management entities oversee maintenance on the property during that property's blackout period, where maintenance on the property comprises maintaining the property, refurbishing the property, remodeling the property, repairing the property, relocating the property, renting the property or any combination thereof.

20. The method of claim 17, where the single property is a yacht, where the other properties are yachts, and where one or more management entities provide the owners of the yachts with a comprehensive management program that comprises maintenance of the yachts, crew staffing of the yachts, arranging for dockage of the yacht, arranging for insuring the yachts, overseeing legal issues related to the yachts, permitting, licensing or registration of the yachts, provisioning of the yachts, and payment of a majority of the expenses and taxes associated with owning the yachts, renting the yachts, or any combination thereof.
